(19) United States
(12) Patent Application Publication
(10) Pub. No.: US 2025/0034367 A1
(43) Pub. Date: Jan. 30, 2025

(54) SULPHUR-CROSSLINKABLE RUBBER MIXTURE, VULCANISATE OF THE RUBBER MIXTURE, AND VEHICLE TYRE

(71) Applicant: Continental Reifen Deutschland GmbH, Hannover (DE)

(72) Inventors: Menglong Huang, Hannover (DE); Christoph Vatterott, Garbsen (DE); Kathrin Bogusz, Hannover (DE); Carla Recker, Hannover (DE); Julien Davin, Hessisch Oldendorf (DE)

(73) Assignee: Continental Reifen Deutschland GmbH, Hannover (DE)

(21) Appl. No.: 18/716,663

(22) PCT Filed: Nov. 2, 2022
(86) PCT No.: PCT/DE2022/200255

§ 371 Date: Jun. 5, 2024

(30) Foreign Application Priority Data
Dec. 6, 2021 (DE) 10 2021 213846.2

(51) Int. Cl. C08L 7/00; B60C 1/00; B60C 11/00; B60C 13/00; C08K 3/36; C08K 5/548

(52) U.S. Cl. CPC C08L 7/00; B60C 1/0016; B60C 1/0025; B60C 11/0008; C08K 3/36; C08K 5/548; B60C 2011/0025; B60C 2013/006; C08K 2201/006; C08K 2201/014

(57) ABSTRACT

A sulfur-crosslinkable rubber mixture, a vulcanizate thereof, and a vehicle tire. The sulfur-crosslinkable rubber mixture contains at least the following constituents: a) 1 to 30 phf of at least one silane A selected from the silanes having the general empirical formulae A-I) and A-XI): A-I) (R¹)ₒSi—R²⁰—(S—R³⁰)ₘ—Sₓ—(R³⁰—S)ₘ—R²⁰—Si(R¹)ₒ; A-XI) (R¹)ₒSi—R²—(S—R³)_{q}—S—X; and b) 0.5 to 30 phf of at least one silane B selected from the silanes having the general empirical formulae B-I), B-01) and B-02): B-I) (R¹)ₒSi—R⁴—(S—R⁵)ᵤ—S—R⁴—Si(R¹)ₒ; B-01) (R¹)ₒSi—R¹⁰—Si(R¹)ₒ; B-02) (R¹)ₒSi—R⁹; and c) 12 to 300 phr of silicon dioxide having a CTAB surface area to ASTM D 3765 of 190 to 300 m²/g; and d) at least one diene rubber, where x is an integer from 2 to 10; and q is 1 or 2 or 3; and u is 1 or 2 or 3; and X is a hydrogen atom or a —C(═O)—R⁸ group where R⁸ is selected from hydrogen, C₁-C₂₀-alkyl groups, C₆-C₂₀-aryl groups, C₂-C₂₀-alkenyl groups and C₇-C₂₀-aralkyl groups.

The present application is a National Stage Application under 35 U.S.C. § 371 of International Patent Application No. PCT/DE2022/200255 filed on Nov. 2, 2022, and claims priority from German Patent Application No. 10 2021 213 846.2 filed on Dec. 6, 2021, the disclosures of which are herein incorporated by reference in their entireties.

The invention relates to a sulfur-crosslinkable rubber mixture, to the vulcanizate thereof, and to a vehicle tire. The invention further relates to the use of the sulfur-crosslinkable rubber mixture.

To a high degree, the rubber composition of the tread determines the running properties of a vehicle tire, particularly of a pneumatic vehicle tire.

The rubber mixtures which find use particularly in the parts of belts, hoses and cords that are subject to severe mechanical stress are substantially responsible for the stability and long life of these rubber articles. Therefore, very high demands are made on these rubber mixtures for pneumatic vehicle tires, cords, belts and hoses.

There are trade-offs between most of the known tire properties, such as wet grip characteristics, braking characteristics, handling characteristics, rolling resistance, winter properties, abrasion characteristics and friction properties.

Particularly in the case of pneumatic vehicle tires, various attempts have been made to positively influence the properties of the tire through the variation of the polymer components, the fillers and the other admixtures, particularly in the tread mixture.

In this context, it has to be taken into account that any improvement in one tire property often entails a deterioration in another property.

In a given blend system, for example, there exist various known ways of optimizing the handling characteristics by increasing the stiffness of the rubber mixtures. Mention should be made here, for example, of an increase in the filler level and the increase in the node density of the vulcanized rubber mixture. While an increased proportion of filler brings disadvantages in terms of rolling resistance, boosting the network leads to a deterioration in the tear properties and the wet grip indicators of the rubber mixture.

It is also known that rubber mixtures, especially for the tread of pneumatic vehicle tires, may comprise silicon dioxide, especially silica, as filler. A parameter of interest in the case of fillers based on silicon dioxide, especially silicas, is the surface area available. This influences the reinforcing effect in the rubber mixture.

WO 2019016461 discloses a rubber mixture containing a silica having a CTAB surface area of 200 m²/g.

It is additionally known that advantages with regard to the rolling resistance characteristics and processibility of the rubber mixture arise when the silica has been bonded to the polymer(s) by means of silane coupling agents.

Silane coupling agents known in the prior art are disclosed, for example, by DE 2536674 C3 and DE 2255577 C3.

It is possible in principle to draw a distinction between silanes that bond solely to silica or comparable fillers and especially have at least one silyl group for the purpose, and silanes that have, in addition to a silyl group, a reactive sulfur moiety such as, in particular, an Sₓ moiety (with x>or equal to 2) or a mercapto group S—H or blocked S-PG moiety where PG represents a protecting group, such that the silane can also bond to polymers in the sulfur vulcanization by reaction of the Sₓ or S—H moiety or the S-PG moiety after removal of the protecting group.

In some cases the prior art additionally discloses combinations of selected silanes.

EP 1085045 B1 discloses a rubber mixture comprising a combination of a polysulfidic silane (mixture comprising 69% to 79% by weight of disulfide fraction, 21 to 31% by weight of trisulfide fraction and 0% to 8% by weight of tetrasulfide fraction) and a silane which has only one sulfur atom and therefore cannot bond to polymers. Such a silane mixture in conjunction with carbon black and silica as filler achieves an optimized profile of properties with regard to the laboratory predictors for properties including rolling resistance and abrasion and optimal tire properties when used in the tread of pneumatic vehicle tires.

WO 2012092062 discloses a combination of a blocked mercaptosilane (NXT) with filler-reinforcing silanes which have non-reactive alkyl groups between the silyl groups.

WO 2019105614 A1 also discloses a rubber mixture comprising a combination of a silane that bonds to polymers and a filler-reinforcing silane.

It was thus an object of the present invention to provide a rubber mixture which, compared to the prior art, shows a further improvement in the profile of properties comprising rolling resistance characteristics, wear characteristics, especially abrasion resistance, and tear properties, especially tear strength. More particularly, the trade-off between these mentioned properties is to be resolved at a higher level.

At the same time, the rubber mixture is to have good processibility, especially miscibility and extrudability.

This object is achieved by the sulfur-crosslinkable rubber mixture as claimed in claim 1.

It was likewise an object of the present invention to provide a vulcanizate and a vehicle tire that have an improvement in the trade-off between rolling resistance characteristics, abrasion characteristics, especially abrasion resistance, and tear properties, especially tear resistance.

This object is achieved by the vulcanizate as claimed in claim 8 and the vehicle tire as claimed in claim 9.

It was a further object of the present invention to provide industrial rubber articles, such as bellows, conveyor belts, air springs, belts, drive belts or hoses, and also shoe soles which feature an improvement in the trade-off between rolling resistance characteristics, abrasion characteristics, especially abrasion resistance, and tear properties, especially tear resistance.

This object is achieved by the use of the sulfur-crosslinkable rubber mixture of the invention for production of the industrial rubber articles mentioned.

Surprisingly, the rubber mixture of the invention, the vulcanizate of the invention and the vehicle tire of the invention achieve an improvement in the trade-off between rolling resistance characteristics, abrasion characteristics, especially abrasion resistance, and tear properties, especially tear resistance.

At the same time, the rubber mixture of the invention has good processibility, especially miscibility and extrudability, such that the vulcanizate of the invention and the vehicle tire of the invention also have good processibility.

This means that the rubber mixture of the invention, the vulcanizate of the invention and the vehicle tire of the invention likewise achieve an improvement in the trade-off between processibility and the properties mentioned, especially rolling resistance characteristics, abrasion characteristics, especially abrasion resistance, and tear properties, especially tear resistance.

The invention encompasses all the advantageous embodiments reflected in the claims inter alia. The invention especially also encompasses embodiments which result from combination of different features, for example of constituents of the rubber mixture, with different levels of preference for these features, such that the invention also encompasses a combination of a first feature described as “preferred” or described in the context of an advantageous embodiment with a further feature described for example as “particularly preferred”.

There follows a detailed description of the constituents of the sulfur-crosslinkable rubber mixture of the invention.

All details relating to the constituents of the rubber mixture of the invention at any level of preference of these features likewise apply correspondingly to the vulcanizate of the invention, the vehicle tires of the invention and the use of the invention.

The unit “phr” (parts per hundred parts of rubber by weight) used in this document is the standard unit of quantity for mixture recipes in the rubber industry. In this document, the dosage of the parts by weight of the individual substituents is based on 100 parts by weight of the total mass of all rubbers present in the mixture that have a molecular weight M_{w} by GPC of greater than 20 000 g/mol.

According to the invention, the rubber mixture comprises at least one diene rubber as constituent d).

The expression phf (parts per hundred parts of filler by weight) used in this text is the conventional unit of quantity for coupling agents for fillers in the rubber industry.

In the context of the present application, phf relates to all silicon dioxides present, including the silicon dioxides present in accordance with the invention and others. This means that any other fillers present, such as carbon blacks, are not included in the calculation of the amount of silane.

Diene rubbers are rubbers which are formed by polymerization or copolymerization of dienes and/or cycloalkenes and thus have C═C double bonds either in the main chain or in the side groups.

The diene rubber is preferably selected from the group consisting of natural polyisoprene (NR), synthetic polyisoprene (IR), epoxidized polyisoprene (ENR), butadiene rubber (BR), butadiene-isoprene rubber, styrene-butadiene rubber (SBR), in particular solution-polymerized styrene-butadiene rubber (SSBR) and emulsion-polymerized styrene-butadiene rubber (ESBR), styrene-isoprene rubber, liquid rubbers having a molecular weight M_{w} of more than 20 000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile butadiene rubber and hydrogenated styrene-butadiene rubber.

Nitrile rubber, hydrogenated acrylonitrile-butadiene rubber, chloroprene rubber, butyl rubber, halobutyl rubber or ethylene-propylene-diene rubber in particular are used in the production of industrial rubber articles, such as belts, drive belts and hoses, and/or shoe soles. The mixture compositions known to those skilled in the art for these rubbers, which are specific in terms of fillers, plasticizers, vulcanization systems and additives, are preferably used here.

Preferably, the diene rubber d) comprises 5 to 100 phr of polyisoprene, more preferably natural polyisoprene (NR).

The combination of 5 to 100 phr of polyisoprene, more preferably natural polyisoprene (NR), achieves the object underlying the invention in a particularly efficient manner, and the rubber mixture has particularly optimal processibility.

If the rubber mixture contains less than 100 phr of polyisoprene, at least one further rubber, preferably at least one further diene rubber selected from the above list, is present, such that the sum total of the rubbers present is 100 phr by definition.

According to the invention, the rubber mixture contains, as constituent c), 12 to 300 phr of silicon dioxide having a CTAB surface area to ASTM D 3765 of 190 to 300 m²/g, preferably 205 to 270 m²/g, more preferably 220 to 270 m²/g.

The silicon dioxide is preferably amorphous silicon dioxide, for example precipitated silica, which is also referred to as precipitated silicon dioxide. However, it is alternatively also possible to use fumed silicon dioxide for example.

With a CTAB surface area to ASTM D 3765 of 190 to 300 m²/g, preferably 205 to 270 m²/g, more preferably 220 to 270 m²/g, the silicon dioxide c) has a comparatively high surface area.

The associated elevated reinforcing effect in rubber mixtures results in advantageous friction properties, but to the detriment of processibility.

The present invention has surprisingly succeeded in achieving an improvement in friction characteristics with simultaneously improved processibility and with surprisingly good rolling resistance and tear properties.

It has surprisingly been possible to achieve an improvement in the trade-off between rolling resistance characteristics, abrasion characteristics, especially abrasion resistance, and tear properties, especially tear resistance, and an improvement in the trade-off between the properties mentioned and processibility.

A suitable silicon dioxide having a CTAB surface area of 240 to 250 m²/g is available, for example, under the Premium FW trade name from Solvay.

It has additionally been found that, surprisingly, particularly good properties, especially in the trade-off between rolling resistance characteristics, friction characteristics, especially abrasion resistance, and tear characteristics, especially tear resistance, and the processibility of the rubber mixture, are achieved when a specific selection of the type and amount of diene rubber d) and of the silicon dioxide c) is made.

In advantageous embodiments of the invention, the rubber mixture contains the following constituents:
c) 12 to 80 phr of silicon dioxide having a CTAB surface area to ASTM D 3765 of 190 to 300 m²/g, preferably 205 to 270 m²/g, more preferably 220 to 270 m²/g; and
as diene rubber d) 50 to 100 phr, preferably 50 to 90 phr, more preferably 70 to 90 phr, of at least one natural polyisoprene (NR) and
0 to 50 phr, preferably 10 to 50 phr, more preferably 10 to 30 phr, of at least one diene rubber preferably selected from the group consisting of butadiene rubbers (BR) and styrene-butadiene rubber (SBR), where the styrene-butadiene rubber is preferably selected from solution-polymerized styrene-butadiene rubber (SSBR).

Such a rubber mixture achieves the object underlying the invention particularly efficiently, in that the rubber mixture, the vulcanizate and the vehicle tire surprisingly have particularly good abrasion and tear properties.

The rubber mixture in these aforementioned embodiments preferably additionally contains comparatively small amounts of plasticizers I), preferably amounts of 0 to 20 phr. The plasticizer(s) I) present is/are preferably selected from the substances specified below.

In further advantageous embodiments of the invention, the rubber mixture contains the following constituents:
c) 60 to 300 phr of silicon dioxide having a CTAB surface area to ASTM D 3765 of 190 to 300 m²/g, preferably 205 to 270 m²/g, more preferably 220 to 270 m²/g; and
as diene rubber d) 0 to 20 phr, preferably 5 to 20 phr, of at least one natural polyisoprene (NR) and
80 to 100 phr, preferably 80 to 95 phr, of at least one diene rubber preferably selected from the group consisting of butadiene rubbers (BR) and styrene-butadiene rubber (SBR), where the styrene-butadiene rubber is preferably selected from solution-polymerized styrene-butadiene rubber (SSBR).

Such a rubber mixture achieves the object underlying the invention particularly efficiently.

The rubber mixture in these aforementioned embodiments preferably additionally contains comparatively large amounts of plasticizers I), preferably amounts of more than 15 phr. The plasticizer(s) I) present is/are preferably selected from the substances mentioned below and, in preferred embodiments, comprise(s) at least one hydrocarbon resin and/or at least one oil.

The rubber mixture of the invention including all the embodiments may additionally contain at least one further filler that has a reinforcing effect or does not have a reinforcing effect.

Further reinforcing fillers are especially carbon blacks, preferably selected from industrial carbon blacks and pyrolysis carbon blacks, more preferably industrial carbon blacks, and further silicon dioxides having a CTAB surface area to ASTM D 3765 of less than 190 m²/g.

In advantageous embodiments of the invention, the rubber mixture contains, as well as constituent c) present, at least one further reinforcing filler selected from the group consisting of carbon blacks, preferably selected from industrial carbon blacks and pyrolysis carbon blacks, more preferably industrial carbon blacks, and further silicon dioxides having a CTAB surface area to ASTM D 3765 of less than 190 m²/g.

Suitable carbon blacks include any carbon black types known to those skilled in the art.

It is preferable when the carbon black has an iodine number according to ASTM D 1510, also known as the iodine adsorption number, between 30 and 250 g/kg, preferably 30 to 180 g/kg, particularly preferably 40 to 180 g/kg, and very particularly preferably 40 to 130 g/kg, and a DBP number according to ASTM D 2414 of 30 to 200 ml/100 g, preferably 70 to 200 ml/100 g, particularly preferably 90 to 200 ml/100 g.

The DBP number in accordance with ASTM D 2414 determines the specific absorption volume of a carbon black or a light-colored filler by means of dibutyl phthalate.

The use of such a type of carbon black in the rubber mixture, in particular for vehicle tires, ensures the best possible compromise between abrasion resistance and heat buildup, which in turn influences the ecologically relevant rolling resistance.

A particularly suitable and preferred carbon black is one having an iodine adsorption number between 80 and 110 g/kg and a DBP number of 100 to 130 ml/100 g, such as in particular carbon blacks of the type N339.

The further silicon dioxide is preferably amorphous silicon dioxide, for example precipitated silica, which is also referred to as precipitated silicon dioxide. However, it is alternatively also possible to use fumed silicon dioxide for example.

However, particular preference is given to using a finely divided, precipitated silica having a CTAB surface area (to ASTM D 3765) of 30 to 189 m²/g, more preferably of 115 to 189 m²/g.

It is also possible to use silicon dioxide obtained from the residue of combustion of rice hulls.

Within the context of the present invention, the further (non-reinforcing) fillers include aluminosilicates, kaolin, chalk, starch, magnesium oxide, titanium dioxide, or rubber gels and also fibers (for example aramid fibers, glass fibers, carbon fibers, cellulose fibers).

Further, optionally reinforcing fillers are for example carbon nanotubes ((CNTs), including discrete CNTs, hollow carbon fibers (HCF) and modified CNTs comprising one or more functional groups such as hydroxy, carboxy and carbonyl groups), graphite and graphene and what is known as “carbon-silica dual-phase filler”.

In the context of the present invention zinc oxide is not included among the fillers.

According to the invention, the rubber mixture contains
a) 1 to 30 phf, preferably 3 to 30 phf, more preferably 3 to 20 phf, most preferably 5 to 15 phf, of at least one silane A selected from the silanes having the general empirical formulae A-I) and A-XI):

(R¹)ₒSi—R²⁰—(S—R³⁰)ₘ—Sₓ—(R³⁰—S)ₘ—R²⁰—Si(R¹)ₒ; A-I)

(R¹)ₒSi—R²—(S—R³)_{q}—S—X; and A-XI)
b) 0.5 to 30 phf, preferably 2 to 30 phf, more preferably 3 to 15 phf, most preferably 3 to 10 phf, of at least one silane B selected from the silanes having the general empirical formulae B-I), B-01) and B-02):

(R¹)ₒSi—R⁴—(S—R⁵)ᵤ—S—R⁴—Si(R¹)ₒ; B-I)

(R¹)ₒSi—R¹⁰—Si(R¹)ₒ; B-01)

(R¹)ₒSi—R⁹; B-02)
where the indices o are independently 1, 2 or 3; and the R¹ radicals are the same or different and are selected from C₁-C₂₀-alkoxy groups, C₆-C₂₀-phenoxy groups, C₂-C₁₀-cyclic dialkoxy groups, C₂-C₂₀-dialkoxy groups, C₄-C₂₀-cycloalkoxy groups, C₆-C₂₀-aryl groups, C₁-C₂₀-alkyl groups, C₂-C₂₀-alkenyl groups, C₂-C₂₀-alkynyl groups, C₇-C₂₀-aralkyl groups, halides or alkyl polyether groups —O—(R⁶—O)ᵣ—R⁷, where the R⁶ radicals are the same or different and are branched or unbranched, saturated or unsaturated, aliphatic, aromatic or mixed aliphatic/aromatic divalent C₁-C₃₀-hydrocarbyl groups, r is an integer from 1 to 30, and the R⁷ radicals are unsubstituted or substituted, branched or unbranched, monovalent alkyl, alkenyl, aryl or aralkyl groups, or two R¹ correspond to a dialkoxy group having 2 to 10 carbon atoms, in which case o<3, or it is possible for two or more silanes of the formulae A-I), A-XI), B-I), B-01) and/or B-02) to be bridged via R¹ radicals or by condensation, in which case
for each molecule is <3; and with the condition that, in the formulae A-I), A-XI), B-I), B-01) and B-02), in each (R¹)ₒSi group, at least one R¹ is selected from those abovementioned options in which said R¹
i) is bonded to the silicon atom via an oxygen atom or ii) is a halide; and
where the R⁹ radical is selected from the C₆-C₂₀-aryl groups, C₁-C₂₀-alkyl groups, C₂-C₂₀-alkenyl groups, C₂-C₂₀-alkynyl groups, C₇-C₂₀-aralkyl groups; and
where the R², R³, R⁴, R⁵, R¹⁰, R²⁰, R³⁰ radicals in each molecule and within a molecule are the same or different and are branched or unbranched, saturated or unsaturated,
aliphatic, aromatic or mixed aliphatic/aromatic divalent C₁-C₃₀ hydrocarbyl groups; and where x is an integer from 2 to 10;
and where m is 0 or 1 or 2 or 3;
and q is 1 or 2 or 3;
and u is 1 or 2 or 3; and X is a hydrogen atom or a —C(═O)—R⁸ group where R⁸ is selected from hydrogen, C₁-C₂₀-alkyl groups, C₆-C₂₀-aryl groups, C₂-C₂₀-alkenyl groups and C₇-C₂₀-aralkyl groups.

The silane A present in accordance with the invention as constituent a), by virtue of the Sₓ— where the index x is an integer from 2 to 10, or by virtue of the S—X moiety, is a silane that can bind to polymers. This is possible in the case of the S—X moiety by elimination of X, i.e. of the hydrogen atom or the —C(═O)—R⁸ group.

In the case of the Sₓ moiety with x=2 to 10, this is enabled by elimination of the polysulfide group.

It is also possible for various silanes of type A), i.e. with different Sₓ— and/or S—X groups, to be present in a mixture.

The silane B present in accordance with the invention comprises individual sulfur atoms (S₁), or none, which cannot bind to the polymer chains of the diene rubber since the chemical bond —C—S—C— is typically not broken during the vulcanization.

The silane B present in accordance with the invention as constituent b) is thus what is called a “non-binding” silane, which in particular means “non-binding to diene rubbers”.

It is also possible for different silanes of type B) to be present in a mixture.

The remarks that follow with regard to R¹ are applicable to the silanes of the formulae A-I), A-XI), B-I), B-01) and B-02).

All the R¹ radicals and bridges mentioned from one or more silanes via R¹ radicals may be combined with one another within a silyl group.

If two R¹ correspond to a dialkoxy group having 2 to 10 carbon atoms and then o<3 (o is less than 3), the silicon atom is part of a ring system. In analogy to a ligand, the dialkoxy group is counted only once here, although it will be clear to the person skilled in the art that one dialkoxy group in this case satisfies two of a total of four valences of the silicon atom.

If two silanes of the formulae A-I), A-XI), B-I), B-01) and/or B-02) are bridged to one another, they share an R¹ radical or are joined to one another via an oxygen atom by combination of two Si—R¹— groups. It is also possible for more than two silanes to be joined to one another in this way.

The rubber mixture of the invention may thus also contain oligomers that form through hydrolysis and condensation or through bridging by means of dialkoxy groups as R¹ of the silanes A and/or silanes B.

It is apparent from this in theoretical terms that the index o per molecule is less than 3 (o<3).

The silanes of the formulae A-I), A-XI), B-I), B-01) and B-02), by virtue of the condition that, in the formulae A-I), A-XI), B-I), B-01) and B-02), in each (R¹)ₒSi— group there is at least one R¹ selected from those abovementioned options where this R¹ i) is bonded to the silicon atom via an oxygen atom or ii) is a halide, each comprise at least one R¹ radical that can serve as leaving group.

These are thus especially alkoxy groups, phenoxy groups or all other groups mentioned that are bonded to the silicon atom by an oxygen atom, or halides.

It is preferable that the R¹ radicals comprise alkyl groups having 1 to 6 carbon atoms or alkoxy groups having 1 to 6 carbon atoms, or halides, more preferably alkoxy groups having 1 to 6 carbon atoms.

In a particularly advantageous embodiment of the invention, the R¹ radicals within a silyl group (R¹)ₒSi— are the same and are alkoxy groups having 1 or 2 carbon atoms, i.e. methoxy groups or ethoxy groups, most preferably ethoxy groups, where o is 3.

But even in the case of oligomers or if two R¹ form a dialkoxy group, the remaining R¹ radicals are preferably alkyl groups having 1 to 6 carbon atoms or halides or alkoxy groups having 1 to 6 carbon atoms, preferably 1 or 2 carbon atoms, i.e. methoxy groups or ethoxy groups, most preferably ethoxy groups.

In the context of the present invention, ethoxy groups in the formulae of the silanes are abbreviated to EtO or OEt. The two notations illustrate that alkoxy groups such as ethoxy groups are bonded to the silicon atom Si via the oxygen atom O.

In principle, however, the abbreviations OEt and EtO can be used synonymously in the context of the present invention.

In advantageous embodiments of the invention, the rubber mixture contains, as silane A, the silane of formula A-XI):

(R¹)ₒSi—R²—(S—R³)_{q}—S—X. A-XI)

A silane of the formula A-XI) achieves the object underlying the invention particularly efficiently.
X is a hydrogen atom or a —C(═O)—R⁸ group, where R⁸ is selected from hydrogen, C₁-C₂₀ alkyl groups, preferably C₁-C₁₇,
C₆-C₂₀ aryl groups, preferably phenyl,
C₂-C₂₀ alkenyl groups and C₇-C₂₀ aralkyl groups.

It is preferable when X is a —C(═O)—R⁸ group, where R⁸ is more preferably a C₁-C₂₀ alkyl group and X is thus an alkanoyl group.

In an advantageous embodiment, the alkanoyl group has a total of one to three and especially two carbon atoms.

In a further advantageous embodiment, the alkanoyl group has a total of seven to nine and especially eight carbon atoms.

The R² and R³ radicals are branched or unbranched, saturated or unsaturated, aliphatic, aromatic or mixed aliphatic/aromatic divalent C₁-C₃₀ hydrocarbyl groups.

Preferably, R² is an alkylene group having two to six carbon atoms, more preferably having two or three carbon atoms, most preferably having three carbon atoms, and hence a propylene group.

The index q may assume the values 1 or 2 or 3. Preferably, q=1.

Preferably, R³ is an alkylene group having two to twelve carbon atoms, more preferably having 4 to eight carbon atoms, most preferably having six carbon atoms, and hence a hexylene group.

In a particularly advantageous embodiment of the invention, the rubber mixture contains, as silane A, from 1 to 30 phf, preferably 3 to 30 phf, more preferably 3 to 20 phf, most preferably 5 to 15 phf, of the silane of formula A-XII):

(EtO)₃Si—(CH₂)₃—S—(CH₂)₆—S—C(═O)—CH₃. A-XII)

A silane of the formula A-XII) achieves the object underlying the invention particularly efficiently.

In further particularly advantageous embodiments of the invention, the rubber mixture contains, as silane A, from 1 to 30 phf of the silane of formula A-XIII):

(EtO)₃Si—(CH₂)₃—S—(CH₂)₆—S—C(═O)—(CH₂)₆—CH₃. A-XIII)

In further advantageous embodiments of the invention, the rubber mixture contains, as silane A, the silane of formula A-I):

(R¹)ₒSi—R²⁰—(S—R³⁰)ₘ—Sₓ—(R³⁰—S)ₘ—R²⁰—Si(R¹)ₒ. A-I)

In advantageous embodiments of the invention, in formula A-I), m on either side of the molecule is 0 and R²⁰ is an alkylene group having two to twelve carbon atoms, more preferably having six to ten carbon atoms, most preferably having eight carbon atoms, and hence an octylene group.

The index x of the polysulfide group Sₓ in formula A-I) is preferably an integer from two to six, especially and preferably two to four.

In advantageous embodiments of the invention, x in formula A-I) is two.

In advantageous embodiments of the invention, x in formula A-I) is four.

In particularly advantageous embodiments of the invention, the silane of the general formula I-I) has the structure of formula A-II):

(EtO)₃Si—(CH₂)₈—S₂—(CH₂)₈—Si(OEt)₃. A-II)

In particularly advantageous embodiments of the invention, the silane of the general formula I-I) has the structure of formula A-III):

(EtO)₃Si—(CH₂)₈—S₄—(CH₂)₈—Si(OEt)₃. A-III)

In further advantageous embodiments of the invention, in formula A-I), R²⁰ on either side of the molecule is the same and is an alkylene group having two to six carbon atoms, more preferably having two or three carbon atoms, most preferably having three carbon atoms, and hence a propylene group.

In advantageous embodiments of the invention, in formula A-I), m on either side of the molecule is one and R³⁰ is preferably the same on either side of the molecule and is an alkylene group having two to twelve carbon atoms, more preferably having four to eight carbon atoms, most preferably having six carbon atoms, and hence a hexylene group.

In this case, it is additionally preferable that R²⁰ on either side of the molecule is the same and is an alkylene group having two to six carbon atoms, more preferably having two or three carbon atoms, most preferably having three carbon atoms, and hence a propylene group.

In particularly advantageous embodiments of the invention, the silane of the general formula A-I) has the structure of formula A-IV):

(EtO)₃Si—(CH₂)₃—S—(CH₂)₆—Sₓ—(CH₂)₆—S—(CH₂)₃—Si(OEt)₃, A-IV)

where x is an integer from two to ten, preferably two to six, more preferably two to four, and is most preferably two.

In advantageous embodiments of the invention, the rubber mixture contains, as silane B, the silane of formula B-I):

R¹)ₒSi—R⁴—(S—R⁵)ᵤ—S—R⁴—Si(R¹)ₒ. B-I)

A silane of the formula B-I) achieves the object underlying the invention particularly efficiently.

Preferably, in formula B-I), R⁴ on either side of the molecule is the same and is an alkylene group having two to six carbon atoms, more preferably having two or three carbon atoms, most preferably having three carbon atoms, and hence a propylene group.

In advantageous embodiments of the invention, u in formula B-I) is 1.

Preferably, R⁵ is an alkylene group having two to twelve carbon atoms, more preferably having four to eight carbon atoms, most preferably having six carbon atoms, and hence a hexylene group.

In particularly advantageous embodiments of the invention, the rubber mixture contains, as silane B, from 0.5 to 30 phf, preferably 2 to 30 phf, more preferably 3 to 15 phf, most preferably 3 to 10 phf, of the silane of formula B-II):

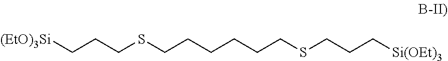

and hence, in written form, (EtO)₃Si—(CH₂)₃—S—(CH₂)₆—S—(CH₂)₃—Si(OEt)₃.

A silane of the formula B-II) achieves the object underlying the invention particularly efficiently.

In further advantageous embodiments of the invention, the rubber mixture contains, as silane B, the silane of formula B-01):

(R¹)ₒSi—R¹⁰—Si(R¹)ₒ. B-01)

Preferably, the R¹⁰ radical in formula B-01) is an alkylene group having two to twelve carbon atoms, more preferably having six to ten carbon atoms, most preferably having eight carbon atoms, and hence an octylene group.

In particularly advantageous embodiments of the invention, the silane of the general formula B-01) has the structure of formula B-011):

(EtO)₃Si—(CH₂)₈—Si(OEt)₃. B-011)

In further advantageous embodiments of the invention, the rubber mixture contains, as silane B, the silane of formula B-02):

(R¹)ₒSi—R⁹. B-02)

Preferably, the R⁹ radical in formula B-02) is an alkyl group having two to twelve carbon atoms, more preferably having six to ten carbon atoms, most preferably having eight carbon atoms, and hence an octyl group.

In particularly advantageous embodiments of the invention, the silane of the general formula B-02) has the structure of formula B-021):

(EtO)₃Si—(CH₂)₇—CH₃. B-021)

In particularly advantageous embodiments of the invention, the rubber mixture contains 1 to 30 phf, preferably 3 to 30 phf, more preferably 3 to 20 phf, most preferably 5 to 15 phf, of at least one silane A having the general empirical formula A-XI) and q is 1 and/or R³ is an alkylene group having four to twelve carbon atoms, preferably four to eight carbon atoms, and/or X is an alkanoyl group; and
the rubber mixture contains 0.5 to 30 phf, preferably 2 to 30 phf, more preferably 3 to 15 phf, most preferably 3 to 10 phf, of at least one silane B having the general empirical formula B-I) and u is one and/or R⁵ is an alkylene group having four to twelve carbon atoms, preferably four to eight carbon atoms.

In very particularly advantageous embodiments of the invention, the rubber mixture contains 1 to 30 phf, preferably 3 to 30 phf, more preferably 3 to 20 phf, most preferably 5 to 15 phf, of at least one silane A having the general empirical formula A-XI) and q is one and/or R³ is an alkylene group having four to twelve carbon atoms, preferably four to eight carbon atoms, and/or X is an alkanoyl group; and
the rubber mixture contains 0.5 to 30 phf, preferably 2 to 30 phf, more preferably 3 to 15 phf, most preferably 3 to 10 phf, of at least one silane B having the general empirical formula B-I) and u is one and/or R⁵ is an alkylene group having four to twelve carbon atoms, preferably four to eight carbon atoms.

In other particularly advantageous embodiments again, the rubber mixture contains 1 to 30 phf, preferably 3 to 30 phf, more preferably 3 to 20 phf, most preferably 5 to 15 phf, of at least one silane A having the structure of formula A-XII) and 0.5 to 30 phf, preferably 2 to 30 phf, more preferably 3 to 15 phf, most preferably 3 to 10 phf, of at least one silane B having the structure of formula B-II).

With such a combination of silanes A and B in combination with the further constituents present in accordance with the invention, the object underlying the invention is achieved particularly efficiently.

Preferably, the total amount of silanes A present including all the embodiments is 3 to 30 phf, more preferably 3 to 20 phf, most preferably 5 to 15 phf.

Preferably, the total amount of silanes B present including all the embodiments is 2 to 30 phf, more preferably 3 to 15 phf, most preferably 3 to 10 phf.

Especially with the preferred, particularly preferred and very particularly preferred amounts and embodiments of silanes A and B, very good properties arise with regard to the trade-offs between abrasion, rolling resistance, tear properties and processibility of the rubber mixture.

It is particularly preferable when the molar ratio of silanes A present to silanes B present is 20:80 to 90:10, preferably 45:55 to 80:20.

This achieves the object underlying the invention particularly efficiently.

The rubber mixture may further contain customary additives in customary parts by weight which are added preferably in at least one primary mixing stage during the production of said mixture. These additives include
e) aging stabilizers, for example diamines such as N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD), and/or dihydroquinolines such as 2,2,4-trimethyl-1,2-dihydroquinoline (TMQ), and/or substituted bisphenols such as 2,2′-methylenebis(4-methyl-6-tert-butylphenol) (BPH), and/or substituted phenols such as butylhydroxytoluene (BHT),
f) activators, for example zinc oxide and fatty acids (e.g. stearic acid) and/or other activators, such as zinc complexes, for example zinc ethylhexanoate,
g) further activators and/or agents for binding fillers, in particular carbon black or silicon dioxide, for example S-(3-aminopropyl)thiosulfuric acid and/or metal salts thereof (bonding of carbon black) and further silane coupling agents (binding to silicon dioxide, in particular silica) apart from the silanes A and B present in accordance with the invention,
h) antiozonant waxes,
i) hydrocarbon resins such as, in particular, phenolic resins, in particular as tackifying resins,
j) masticating aids, for example 2,2′-dibenzamidodiphenyl disulfide (DBD), and
k) processing aids such as, in particular, fatty acid esters and metal soaps, for example zinc soaps and/or calcium soaps,
l) plasticizers such as, in particular, aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) preferably having a content of polycyclic aromatics of less than 3% by weight by method IP 346 or triglycerides, for example rapeseed oil or factices or hydrocarbon resins or liquid polymers having an average molecular weight (determination by GPC=gel permeation chromatography, in accordance with BS ISO 11344:2004) between 500 and 20 000 g/mol.

When using mineral oil this is preferably selected from the group consisting of DAE (distillate aromatic extracts), RAE (residual aromatic extract), TDAE (treated distillate aromatic extracts), MES (mild extracted solvents) and naphthenic oils.

The total proportion of further additives is preferably 3 to 150 phr, more preferably 3 to 100 phr and most preferably 5 to 80 phr.

Zinc oxide (ZnO) may be included in the total proportion of further additives in the abovementioned amounts.

This may be any type of zinc oxide known to those skilled in the art, for example ZnO granules or powder. The zinc oxide conventionally used generally has a BET surface area of less than 10 m²/g. However, it is also possible to use a zinc oxide having a BET surface area of 10 to 100 m²/g, for example “nano zinc oxides”.

The rubber mixture of the invention is preferably used in vulcanized form, in particular in vehicle tires or other vulcanized industrial rubber articles.

The terms “vulcanized” and “crosslinked” are used synonymously in the context of the present invention.

The vulcanization of the rubber mixture of the invention is preferably conducted in the presence of sulfur and/or sulfur donors with the aid of vulcanization accelerators, it being possible for some vulcanization accelerators to act simultaneously as sulfur donors. The accelerator is selected from the group consisting of thiazole accelerators, mercapto accelerators, sulfenamide accelerators, thiocarbamate accelerators, thiuram accelerators, thiophosphate accelerators, thiourea accelerators, xanthogenate accelerators and guanidine accelerators.

It is preferable to use at least one sulfenamide accelerator selected from the group consisting of N-cyclohexyl-2-benzothiazolesulfenamide (CBS), N,N-dicyclohexylbenzothiazole-2-sulfenamide (DCBS), benzothiazyl-2-sulfenmorpholide (MBS), N-tert-butyl-2-benzothiazylsulfenamide (TBBS), N-tert-butyl-2-benzothiazolesulfenimide (TBSI) and/or at least one guanidine accelerator, such as diphenylguanidine (DPG).

It is especially also possible to use two or more accelerators.

The sulfur donor substance used may be any sulfur donor substances known to those skilled in the art.

It is also possible in the rubber mixture to use one or more reversion stabilizers, for example 1,6-bis(N,N-dibenzylthiocarbamoyldithio)hexane, hexamethylene-1,6-bis(thiosulfate) disodium salt dihydrate and/or tetrabenzyl thiuram disulfide (TBzTD).

Vulcanization retarders may also be present in the rubber mixture.

Production of the rubber mixture is otherwise carried out by the process customary in the rubber industry comprising initially producing in one or more mixing stages a primary mixture comprising all constituents except the vulcanization system (for example sulfur and vulcanization-influencing substances). The finished mixture is produced by adding the vulcanization system in a final mixing stage.

The finished mixture is for example processed further and brought into the appropriate shape by means of an extrusion operation or calendering.

The rubber mixture of the invention is particularly suitable for use in vehicle tires, especially pneumatic vehicle tires. In this context, use in all tire components is conceivable in principle, in particular and preferably in the tread and/or sidewall, most preferably in the tread. In the case of a tread with cap/base construction, the rubber mixture of the invention is preferably used at least in the cap.

For use in vehicle tires the mixture as a finished mixture prior to vulcanization is brought into the corresponding shape, preferably of a sidewall and/or a tread, and during production of the green vehicle tire is applied in the known manner.

The rubber mixture of the invention for use as any other body mixture in vehicle tires is produced as described above. The difference lies in the shaping after the extrusion operation/the calendering of the mixture. The shapes thus obtained of the as-yet unvulcanized rubber mixture for one or more different body mixtures then serve for the construction of a green tire.

“Body mixture” refers here to the rubber mixtures for the other components of a tire, such as essentially the flange profile, squeegee, inner liner (inner layer), core profile, belt, shoulder, belt profile, carcass, bead reinforcement, bead profile and bandage. For use of the rubber mixture of the invention in drive belts and other belts, especially in conveyor belts, the extruded, as-yet unvulcanized mixture is brought into the appropriate shape and often provided at the same time or subsequently with strength members, for example synthetic fibers or steel cords.

This is followed by further processing by vulcanization.

As mentioned above, the present invention also provides a vulcanizate obtained by sulfur vulcanization of at least one rubber mixture of the invention including all its preferred features.

As mentioned above, the present invention also provides a vehicle tire which in at least one component comprises at least one vulcanizate of the invention including all its preferred features.

In the context of the present invention, “vehicle tires” mean pneumatic vehicle tires and all-rubber tires, including tires for industrial and construction site vehicles, truck, car and two-wheeler tires.

Preference is given to a vehicle tire according to the invention which comprises at least one vulcanizate of the invention, including all of its preferred features, at least in the tread and/or the sidewall, more preferably at least in the tread.

As mentioned above, the present invention further provides for the use of the sulfur-crosslinkable rubber mixture of the invention, including all of its preferred features, for production of industrial rubber articles, such as bellows, conveyor belts, air springs, belts, drive belts or hoses, and also shoe soles.

The invention will now be illustrated in detail by comparative examples and working examples which are summarized in table 1.

The inventive example is identified as E1 and the comparative example as V1.

### Substances Used

1) silica, Zeosil® 1165MP, from Solvay, CTAB surface area 160 m²/g
2) silica, Premium SW, from Solvay, CTAB surface area 240 to 250 m²/g
3) 3-octanoylthio-1-propyltriethoxysilane, NXT, from Momentive
4) silane A having the structure of formula A-XII): (EtO)₃Si—(CH₂)₃—S—(CH₂)₆—S—C(═O)—CH₃
5) silane B having the structure of formula B-II): (EtO)₃Si—(CH₂)₃—S—(CH₂)₆—S—(CH₂)₃—Si(OEt)₃
6) zinc oxide, stearic acid, plasticizer, zinc soap, aging stabilizer, antiozonant wax
7) sulfenamide accelerator and sulfur

The silane of formula A-XII) was prepared as follows:

Na₂CO₃ (59.78 g; 0.564 mol) and an aqueous solution of NaSH (40% in water; 79.04 g; 0.564 mol) formed an initial charge with water (97.52 g). Then tetrabutylphosphonium bromide (TBPB) (50% in water; 3.190 g; 0.005 mol) was added, and acetyl chloride (40.58 g; 0.517 mol) was added dropwise over 1 h, keeping the reaction temperature at 25-32° C. On completion of addition of the acetyl chloride, the mixture was stirred at room temperature for 1 h. Then TBPB (50% in water; 3.190 g; 0.005 mol) and 1-chloro-6-thiopropyltriethoxysilylhexane (see above; 167.8 g; 0.470 mol) were added and the mixture was heated at reflux for 3-5 h. The progress of the reaction was monitored by gas chromatography. Once the 1-chloro-6-thiopropyltriethoxysilylhexane had reacted to an extent of >96%, water was added until all salts had dissolved and the phases were separated. The volatile constituents of the organic phase were removed under reduced pressure and
S-(6-((3-(triethoxysilyl)propyl)thio)hexyl) thioacetate) (yield: 90%, molar ratio: 97% S-(6-((3-(triethoxysilyl)propyl)thio)hexyl) thioacetate (silane A-XII), 3% bis(thiopropyltriethoxysilyl)hexane (silane B-II);
% by weight: 96% by weight of S-(6-((3-(triethoxysilyl)propyl)thio)hexyl) thioacetate (silane A-XII), 4% by weight of 1,6-bis(thiopropyltriethoxysilyl)hexane (silane B-II))) as a yellow to brown liquid.

The silane of formula B-II): 1,6-bis(thiopropyltriethoxysilyl)hexane was prepared as follows:

Sodium ethoxide (21% in EtOH; 82.3 g; 0.254 mol; 2.05 eq) is metered into mercaptopropyltriethoxysilane (62.0 g; 0.260 mol; 2.10 eq) such that the reaction temperature does not exceed 35° C. On completion of addition, the mixture is heated at reflux for 2 h. The reaction mixture is then added to 1,6-dichlorohexane (19.2 g; 0.124 mol; 1.00 eq) at 80° C. for 1.5 h. On completion of addition, the mixture is heated at reflux for 3 h and then allowed to cool to room temperature. Precipitated salts are filtered off and the product is freed of the solvent under reduced pressure. The product (yield: 88%, purity: >99% in ¹³C NMR) was obtained as a clear liquid.

NMR method: The molar ratios and mass fractions specified in the examples as analytical results are derived from ¹³C NMR measurements with the following parameters: 100.6 MHz, 1000 scans, CDCl₃ solvent, internal standard for calibration: tetramethylsilane, relaxation aid Cr(acac)₃; to determine the proportion by mass in the product, a defined amount of dimethyl sulfone was added as internal standard and the molar ratios of the products thereto were used to calculate the proportion by mass.

Because of the higher CTAB surface area of the silica in mixture E1 compared to the silica in mixture V1, as is customary in the specialist field, an adjusted amount of the accelerator DPG was used.

The mixture was produced by the process customary in the rubber industry under standard conditions in three stages in a laboratory mixer having a volume of 300 milliliters to 3 liters, in which, firstly, in the first mixing stage (preliminary mixing stage), all constituents apart from the vulcanization system (sulfur and vulcanization-influencing substances) were mixed at 145° C. to 165° C., target temperatures of 152° C. to 157° C., for 200 to 600 seconds.

In the second stage, the mixture from the first stage was mixed once again. Addition of the vulcanization system in the third stage (ready-mixing stage) produced the final mixture, by mixing at 90° C. to 120° C. for 180 to 300 seconds.

All the mixtures were used to prepare test specimens by vulcanization after t95 to t100 (measured on a moving die rheometer according to ASTM D 5289-12/ISO 6502) under pressure at 160° C. to 170° C., and these test specimens were used to determine material properties typical for the rubber industry by the test methods specified hereinbelow.
Shore hardness at room temperature (RT) according to ISO 868, DIN 53 505.
Rebound resilience at room temperature (RT) according to ISO 4662 or ASTM D 1054
Stress value at 300% elongation (M 300), tensile stress and elongation at break at room temperature (RT) according to DIN 53 504

In addition, tire tests were conducted, both in comparative example V1 and in inventive example E1, with the mixture in each case as tread cap. Test methods employed were as follows:
Wet braking: ABS braking from 80 km/h, wet asphalt, low μ
Rolling resistance: according to ISO 28580
Cut & chip: visual assessment after 600 km on dry gravel track, outside temperature T=about 19° C.
Abrasion: weight loss of the respective tires after road use for 15 000 km at an average temperature of 12° C.

TABLE 1

| Constituent | Unit | V1 | E1 |
|---|---|---|---|
| NR | phr | 80 | 80 |
| SBR | phr | 20 | 20 |
| N220 carbon black | phr | 5 | 5 |
| Silica ¹⁾ | phr | 60 | — |
| Silica ²⁾ | phr | — | 60 |
| Silane ³⁾ | phf | 10.0 | — |
| Silane A ⁴⁾ | phf | — | 11.6 |
| Silane B ⁵⁾ | phf | — | 5.7 |
| Other additives ⁶⁾ | phr | 25 | 25 |
| DPG | phr | 1.0 | 1.6 |
| Other vulcachemicals ⁷⁾ | phr | 3.0 | 3.0 |
| Properties of the rubber mixture | | | |
| Shore hardness RT | Shore A | 61 | 67 |
| Rebound resilience RT | % | 53 | 49 |
| M 300 RT | MPa | 12 | 14 |
| Tensile strength | MPa | 19 | 22 |
| Breaking elongation | % | 470 | 470 |
| Tire properties | | | |
| Rolling resistance | % | 100 | 99 |
| Wet braking | % | 100 | 100 |
| Cut & chip | % | 100 | 105 |
| Abrasion | % | 100 | 123 |

As apparent in table 1, the rubber mixture of the invention in tires of the invention surprisingly achieves distinctly improved abrasion characteristics and better tear strength with virtually the same rolling resistance and wet braking characteristics. Moreover, the inventive rubber mixture E1 has optimal processibility, especially miscibility and extrudability.

This means that the trade-off between the properties mentioned is resolved at a higher level by virtue of the rubber mixture of the invention.

1-11. (canceled)

12. A sulfur-crosslinkable rubber mixture containing at least the following constituents:
a) 1 to 30 phf of at least one silane A selected from the silanes having the general empirical formulae A-I) and A-XI):
(R¹)ₒSi—R²⁰—(S—R³⁰)ₘ—Sₓ—(R³⁰—S)ₘ—R²⁰—Si(R¹)ₒ; A-I)
(R¹)ₒSi—R²—(S—R³)_{q}—S—X; and A-XI)
b) 0.5 to 30 phf of at least one silane B selected from the silanes having the general empirical formulae B-I), B-01) and B-02):
(R¹)ₒSi—R⁴—(S—R⁵)ᵤ—S—R⁴—Si(R¹)ₒ; B-I)
(R¹)ₒSi—R¹⁰—Si(R¹)ₒ; B-01)
(R¹)ₒSi—R⁹; B-02)
and
c) 12 to 300 phr of silicon dioxide having a CTAB surface area according to ASTM D 3765 of 190 to 300 m²/g; and
d) at least one diene rubber,
where the indices o are independently 1, 2 or 3; and the R¹ radicals are the same or different and are selected from C₁-C₂₀-alkoxy groups, C₆-C₂₀-phenoxy groups, C₂-C₁₀-cyclic dialkoxy groups, C₂-C₂₀-dialkoxy groups, C₄-C₂₀-cycloalkoxy groups, C₆-C₂₀-aryl groups, C₁-C₂₀-alkyl groups, C₂-C₂₀-alkenyl groups, C₂-C₂₀-alkynyl groups, C₇-C₂₀-aralkyl groups, halides or alkyl polyether groups —O—(R⁶—O)ᵣ—R⁷, where the R⁶ radicals are the same or different and are branched or unbranched, saturated or unsaturated, aliphatic, aromatic or mixed aliphatic/aromatic divalent C₁-C₃₀-hydrocarbyl groups, r is an integer from 1 to 30, and the R⁷ radicals are unsubstituted or substituted, branched or unbranched, monovalent alkyl, alkenyl, aryl or aralkyl groups, or two R¹ correspond to a dialkoxy group having 2 to 10 carbon atoms, in which case o is less than three, or it is possible for two or more silanes of the formulae A-I), A-XI), B-I), B-01) and/or B-02) to be bridged via R¹ radicals or by condensation, in which case
o for each molecule is less than three; and with the condition that, in the formulae A-I), A-XI), B-I), B-01) and B-02), in each (R¹)ₒSi group, at least one R¹ is selected from those abovementioned options in which said R¹
i) is bonded to the silicon atom via an oxygen atom or ii) is a halide; and
where the R⁹ radical is selected from the C₆-C₂₀-aryl groups, C₁-C₂₀-alkyl groups, C₂-C₂₀-alkenyl groups, C₂-C₂₀-alkynyl groups, C₇-C₂₀-aralkyl groups; and
where the R², R³, R⁴, R⁵, R¹⁰, R²⁰, R³⁰ radicals in each molecule and within a molecule are the same or different and are branched or unbranched, saturated or unsaturated, aliphatic, aromatic or mixed aliphatic/aromatic divalent C₁-C₃₀ hydrocarbyl groups;
and where x is an integer from 2 to 10;
and where m is 0 or 1 or 2 or 3;
and q is 1 or 2 or 3;
and u is 1 or 2 or 3; and X is a hydrogen atom or a —C(═O)—R⁸ group where R⁸ is selected from hydrogen, C₁-C₂₀-alkyl groups, C₆-C₂₀-aryl groups, C₂-C₂₀-alkenyl groups and C₇-C₂₀-aralkyl groups.

13. The sulfur-crosslinkable rubber mixture as claimed in claim 12, comprising:
a) 3 to 30 phf of the at least one silane A selected from the silanes having the general empirical formulae A-I) and A-XI);
b) 2 to 30 phf of the at least one silane B selected from the silanes having the general empirical formulae B-I), B-01) and B-02);
c) the silicon dioxide having a CTAB surface area according to ASTM D 3765 of 205 to 270 m²/g; and
d) the at least one diene rubber comprises 5 to 100 phr of polyisoprene.

14. The sulfur-crosslinkable rubber mixture as claimed in claim 13, comprising:
a) 3 to 20 phf of the at least one silane A selected from the silanes having the general empirical formulae A-I) and A-XI); and
b) 3 to 15 phf of the at least one silane B selected from the silanes having the general empirical formulae B-I), B-01) and B-02).

15. The sulfur-crosslinkable rubber mixture as claimed in claim 12, comprising:
a) 5 to 15 phf of the at least one silane A selected from the silanes having the general empirical formulae A-I) and A-XI);
b) 3 to 10 phf of the at least one silane B selected from the silanes having the general empirical formulae B-I), B-01) and B-02);
c) the silicon dioxide having a CTAB surface area according to ASTM D 3765 of 220 to 270 m²/g; and
d) the at least one diene rubber comprises 5 to 100 phr of natural polyisoprene (NR).

16. The sulfur-crosslinkable rubber mixture as claimed in claim 12, wherein it contains 1 to 30 phf of the at least one silane A having the general empirical formula A-XI) and q is 1 and/or R³ is an alkylene group having 4 to 12 carbon atoms, and/or X is an alkanoyl group; and
the rubber mixture contains 0.5 to 30 phf of the at least one silane B having the general empirical formula B-I) and u is 1 and/or R⁵ is an alkylene group having 4 to 12 carbon atoms.

17. The sulfur-crosslinkable rubber mixture as claimed in claim 12, wherein it contains 3 to 20 phf of the at least one silane A having the general empirical formula A-XI) and q is 1 and/or R³ is an alkylene group having 4 to 12 carbon atoms and/or X is an alkanoyl group; and
the rubber mixture contains 3 to 15 phf of the at least one silane B having the general empirical formula B-I) and u is 1 and/or R⁵ is an alkylene group having 4 to 12 carbon atoms.

18. The sulfur-crosslinkable rubber mixture as claimed in claim 12, wherein it contains 5 to 15 phf of the at least one silane A having the general empirical formula A-XI) and q is 1 and/or R³ is an alkylene group having 4 to 8 carbon atoms, and/or X is an alkanoyl group; and
the rubber mixture contains 3 to 10 phf of the at least one silane B having the general empirical formula B-I) and u is 1 and/or R⁵ is an alkylene group having 4 to 8 carbon atoms.

19. The sulfur-crosslinkable rubber mixture as claimed in claim 12, wherein the at least one silane A present is from 1 to 30 phf of the silane of formula A-XII):
(EtO)₃Si—(CH₂)₃—S—(CH₂)₆—S—C(═O)—CH₃. A-XII)

20. The sulfur-crosslinkable rubber mixture as claimed in claim 12, wherein the at least one silane A present is from 5 to 15 phf of the silane of formula A-XII):
(EtO)₃Si—(CH₂)₃—S—(CH₂)₆—S—C(═O)—CH₃. A-XII)

21. The sulfur-crosslinkable rubber mixture as claimed in claim 12 wherein the silane B present is from 0.5 to 30 phf of the silane of formula B-II):

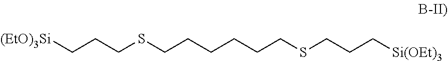

22. The sulfur-crosslinkable rubber mixture as claimed in claim 12 wherein the silane B present is from 3 to 10 phf of the silane of formula B-II):

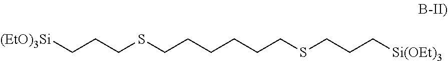

23. The sulfur-crosslinkable rubber mixture as claimed in claim 12, wherein the molar ratio of silanes A present to silanes B present is 20:80 to 90:10.

24. The sulfur-crosslinkable rubber mixture as claimed in claim 12, wherein the molar ratio of silanes A present to silanes B present is 45:55 to 80:20.

25. The sulfur-crosslinkable rubber mixture as claimed in claim 12 wherein it contains the following constituents:
c) 12 to 80 phr of silicon dioxide having a CTAB surface area to ASTM D 3765 of 190 to 300 m²/g; and
as diene rubber d) 50 to 100 phr, of at least one natural polyisoprene (NR) and
0 to 50 phr of at least one further diene rubber.

26. The sulfur-crosslinkable rubber mixture as claimed in claim 12 wherein it contains the following constituents:
c) 12 to 80 phr of silicon dioxide having a CTAB surface area to ASTM D 3765 of 205 to 270 m²/g; and
as diene rubber d) 50 to 90 phr of at least one natural polyisoprene (NR) and
10 to 50 phr of at least one further diene rubber selected from the group consisting of butadiene rubbers (BR) and styrene-butadiene rubber (SBR), where the styrene-butadiene rubber is selected from solution-polymerized styrene-butadiene rubber (SSBR).

27. The sulfur-crosslinkable rubber mixture as claimed in claim 12, wherein it contains the following constituents:
c) 60 to 300 phr of silicon dioxide having a CTAB surface area to ASTM D 3765 of 190 to 300 m²/g; and
as diene rubber d) 5 to 20 phr, of at least one natural polyisoprene (NR) and
80 to 100 phr of at least one further diene rubber selected from the group consisting of butadiene rubbers (BR) and styrene-butadiene rubber (SBR).

28. A vulcanizate obtained by sulfur vulcanization of the at least one rubber mixture as claimed in claim 12.

29. A vehicle tire, wherein it includes at least one vulcanizate as claimed in claim 8 in at least one component.

30. The vehicle tire as claimed in claim 9, wherein the at least one vulcanizate is present at least in the tread and/or the sidewall.

31. The sulfur-crosslinkable rubber mixture as claimed in claim 12 forming at least a part of a bellows, conveyor belt, air spring, belt, drive belt, hose, or shoe sole.
